(19) United States
(12) Patent Application Publication
(10) Pub. No.: US 2024/0208037 A1
(43) Pub. Date: Jun. 27, 2024

(54) RAPID REPOSITIONABLE CONSTRUCTION SHELF

(71) Applicant: Kenneth Johnson, St. Peter, MN (US)

(72) Inventor: Kenneth Johnson, St. Peter, MN (US)

(21) Appl. No.: 18/391,296

(22) Filed: Dec. 20, 2023

Related U.S. Application Data
(60) Provisional application No. 63/476,568, filed on Dec. 21, 2022.

(51) Int. Cl. B25H 1/20; B25H 1/04; B25H 1/12

(52) U.S. Cl. CPC B25H 1/20; B25H 1/04; B25H 1/12

(57) ABSTRACT

Apparatus and associated methods relate to a rapid repositionable construction shelf. In an illustrative example, a repositionable construction shelf may, for example, extend along a longitudinal direction with intersecting opposing protrusions. The opposing protrusions may advantageously be configured such that the opposing protrusions may releasably couple the opposing arms to at least one adjacent vertical construction beam. The opposing protrusions may, for example, be positioned such that a distal protrusion is higher than a proximal protrusion such that the weight of the shelf urges both protrusions to frictionally engage with the vertical construction beam.

### CROSS-REFERENCE TO RELATED APPLICATIONS

This application claims the benefit of U.S. Provisional Application Serial No. U.S. 63/476,568, titled “Rapid Repositionable Construction Shelf,” filed by Kenneth Johnson, on Dec. 21, 2022.

This application incorporates the entire contents of the foregoing application herein by reference.

### TECHNICAL FIELD

Various embodiments relate generally to construction, tools, and tool kits.

### BACKGROUND

Construction involves the process of assembling infrastructure or buildings. It starts with planning, design, and financing, and continues until the project is built and ready for use. Key phases include site preparation, foundation work, structural framing, installation of utilities, interior and exterior finishing, and final inspections. This process requires coordination of various skilled trades and materials.

Tools, integral to various tasks, range from simple hand tools like hammers and screwdrivers to complex power tools like drills and saws. They enable precision, efficiency, and safety in tasks from construction to home repair. Innovations in tool design continually enhance user experience, functionality, and adaptability across numerous applications.

Tool kits are curated collections of essential tools, tailored for specific tasks or professions. They typically include a variety of hand and power tools, such as wrenches, pliers, screwdrivers, and sometimes specialized equipment. These kits offer convenience, organization, and portability, making them indispensable for maintenance, repair, and do-it-yourself projects. Construction professionals and do-it-yourself people alike may employ many tools—including such kits—around a jobsite during use.

### SUMMARY

Apparatus and associated methods relate to a rapidly repositionable construction shelf. In an illustrative example, a repositionable construction shelf may, for example, extend along a longitudinal direction with intersecting opposing protrusions. The opposing protrusions may advantageously be configured such that the opposing protrusions may releasably couple the opposing arms to at least one adjacent vertical construction beam. The opposing protrusions may, for example, be positioned such that a distal protrusion is higher than a proximal protrusion such that the weight of the shelf urges both protrusions to frictionally engage with the vertical construction beam.

Various embodiments may advantageously include a stowage mode configuration. Various embodiments may, for example, advantageously include each configuration where the opposing protrusions extend transversely from the same side of the arm.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary rapid repositionable construction shelf (RRCS) employed in an illustrative use-case scenario.

FIG. 2 is an exemplary RRCS employed in a use case scenario.

FIG. 3 depicts an annotated exemplary RRCS.

FIG. 4 depicts a free body diagram of an exemplary RRCS.

FIG. 5 depicts a customized exemplary RRCS with accessories.

FIG. 6 depicts an exemplary RRCS being coupled to a construction beam.

FIG. 7 depicts a foldable exemplary RRCS.

FIG. 8 depicts an attachment and in-use mode scenario for an exemplary RRCS.

Appendix A depicts an illustrative RRCS system in use.

Appendix B depicts an illustrative deployment of the RRCS system depicted in Appendix A.

Appendix C is a transcription of voice instructions given during the deployment depicted in Appendix B.

Like reference symbols in the various drawings indicate like elements.

### DETAILED DESCRIPTION OF ILLUSTRATIVE EMBODIMENTS

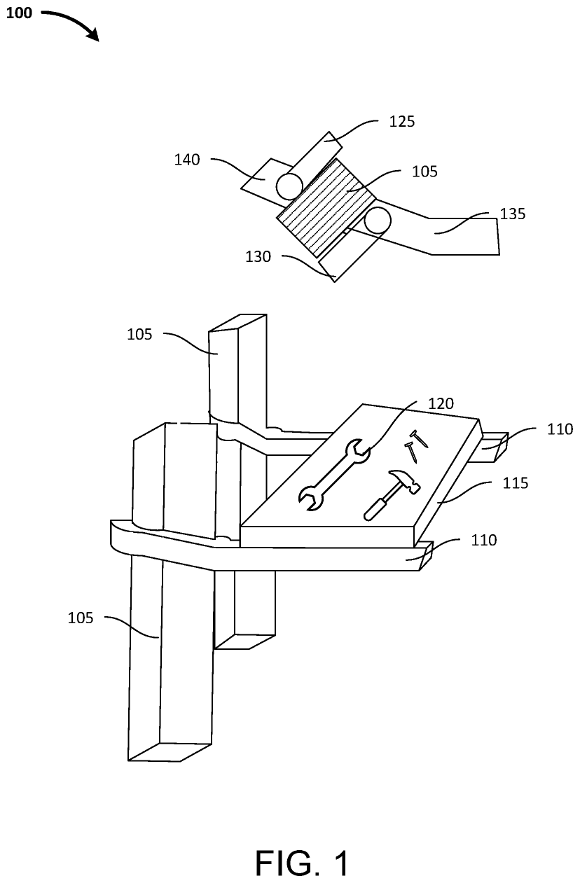

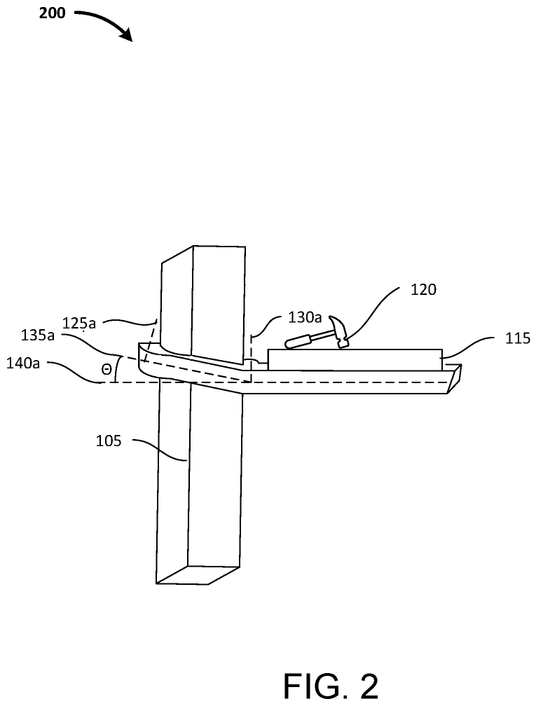

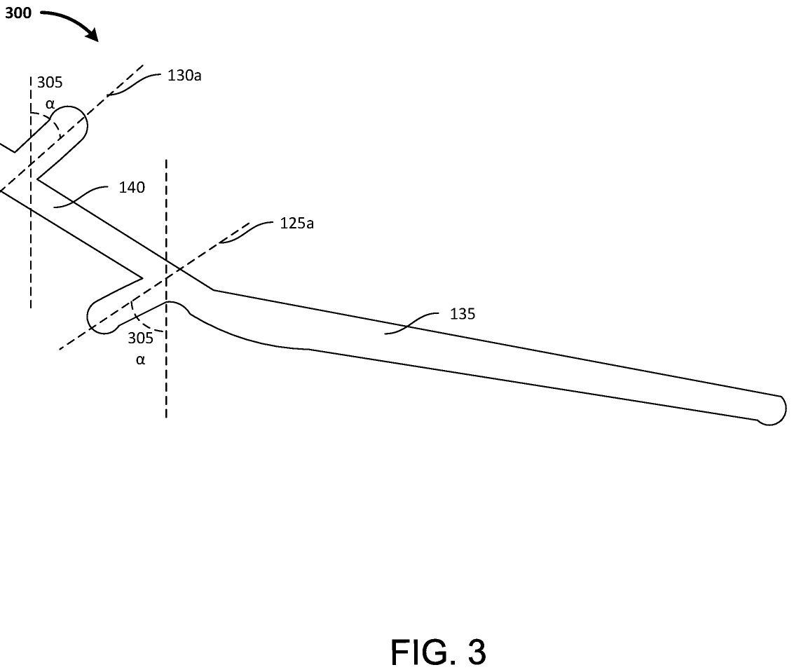

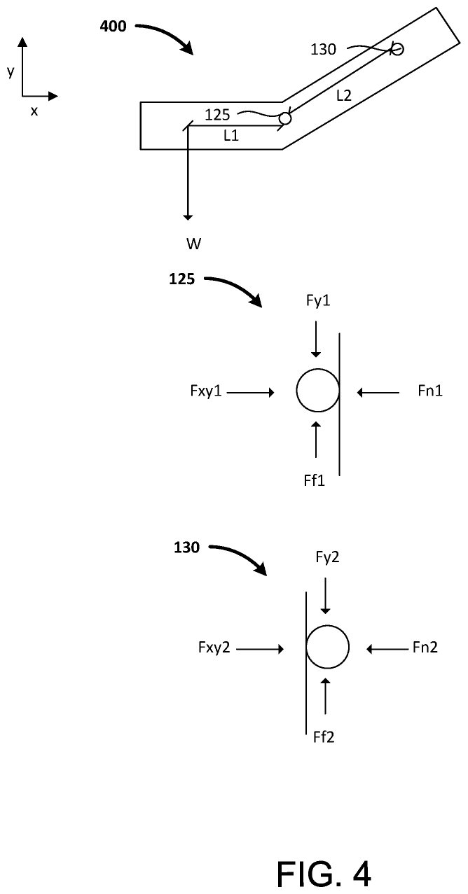

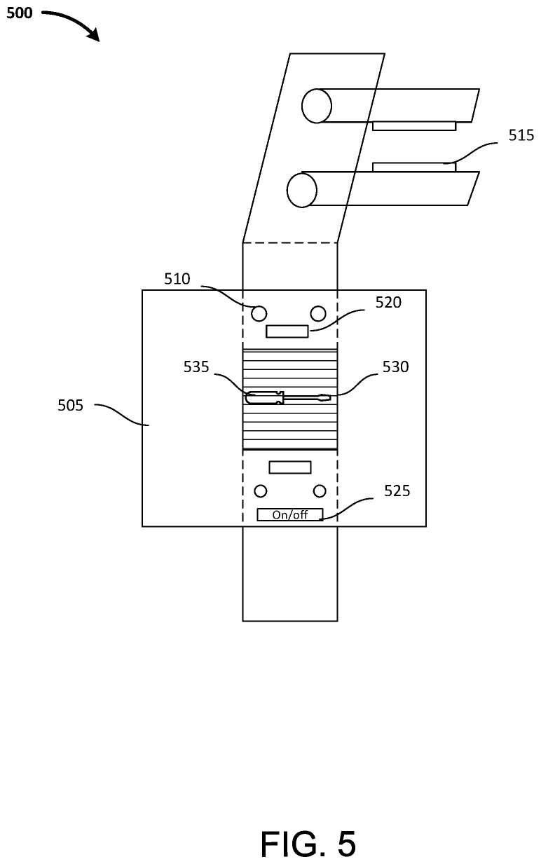

To aid understanding, this document is organized as follows. First, to help introduce discussion of various embodiments, an exemplary construction shelf is introduced with reference to FIGS. 1-2. Second, that introduction leads into a description with reference to FIG. 3 of some the properties on an exemplary embodiment. Third, with reference to FIG. 4, an exemplary construction shelf is described in an illustrative application. Finally, the document discusses further embodiments, exemplary applications and aspects relating to FIGS. 5-8.

FIG. 1A depicts an exemplary construction shelf employed in an illustrative use-case scenario 100. The illustrative use-case scenario 100 depicts a construction beam 105. The dimensions of the construction beam may, for example, be a 4×4 beam and/or a 4×2 beam. The material of the construction beam may, for example, be a made of metal, steel, fiberglass, concrete, wood, and/or timber. The shape of the construction beam may, for example, be configured to be a L beam C Beam, T Beam, I Beam, and/or a rectangular beam.

The construction beam 105 is coupled to a rapid repositionable construction shelf (RRCS) 110. The RRCS may, for example, be attached to the construction beam for a construction project. The RRCS may, for example, be removed from the construction beam after a construction project has been completed. The RRCS supports a shelf 115. The shelf 115 is used to shelf tools 120 or toolboxes while a construction job is being completed. The tools may, for example, include nails, screws, hammers, screw drivers, and/or wrenches. The shelf may, for example, include a stowage insert. The stowage insert may, for example, be configured for an electric drill. The stowage shelf may, for example, include an insert configured for an electric saw. The shelf may, for example, include an insert configured for an electric saw. At least one construction beam may be used to support at least one shelf. For example, one, two, three, and/or four construction beams may be used to support one individual shelf. The tray may, for example, include separate drawers and/or shelves (e.g., for smaller tool parts). The construction beam and the trays may, for example, be configured to be arrayed in a carry case mode (e.g., coupled together and/or carriable as a single unit).

In the depicted exploded view of the construction beam 105 includes a first stud 125. The first stud 125 extends parallel to the second stud 130. The studs couple to the construction beam 105. The construction beam includes a shaft 135. The shaft 135 is connected to a head 140. The head is angled to the shaft. The head 140 houses the first stud 125 and/or the second stud 130. The head's 140 longitudinal direction intersects the longitudinal direction of the shaft 135 in a deployed mode. The RRCS may, for example, enter a carry case mode by aligning the longitudinal direction of the shaft to the longitudinal direction of the shelf.

The studs may, for example, be adjustable. The studs may, for example, be adjusted for beams with different shapes. The studs may, for example, be adjusted for beams with different dimensions.

The material of the studs may, for example, vary. For example, the studs may be made of plastic, steel, and/or wood. The shapes of the studs may vary. The studs may, for example, be semi-circular, square shape, circular, elliptical, semi elliptical, and/or triangular.

In some embodiments. The exemplary RRCS may, for example, include a housing. The housing may, for example, include an insert. The RRCS may, for example, include a light source. The RRCS may, for example, include a battery. The RRCS may, for example, include a human interface switch (HMI). The RRCS may, for example, include a charging port for the battery. The battery may, for example, be used to charge electronic tools such as electronic saws and electronic drills.

FIG. 2 is an exemplary RRCS employed in a use case scenario 200. In illustrative case scenario 200 the RRCS 110 is being coupled to the construction beam 105. The singular RRCS 110 is being used to support the shelf 115. Tools 120 are laid upon the shelf 115. The second stud 130 includes a longitudinal direction 130a. The first stud 125 includes a longitudinal direction 125a. The head part of the RRCS includes a longitudinal direction 135a. The shaft part of the RRCS includes a longitudinal direction 140a. The angle between the head and shaft may, for example, be 10 degrees. The angle between the head and shaft may, for example, be 20 degrees. The angle between the head and shaft may, for example, be 30 degrees. The angle between the head and shaft may, for example, be 45 degrees.

FIG. 3 depicts an annotated exemplary RRCS 300. The first stud 125a is angled from the distal end of the head 140a at a degree α. The second stud 130a is angled from the proximal end of the head 140 at a degree α 305. The head 140 is a length L1. The shaft 135 is a length L2. The length of the shaft L1 is greater than the length of the head L2. The configuration of the weight distribution of the RRCS means that the center of mass of the RRCS may be displaced from the center of the RCCS.

In some embodiments, the RRCS may be used in construction zones. The height distance between the first and second stud allows for the RRCS to attach to a narrow portion of a construction beam. Obstacles may be directly below or above the construction beam at certain points. The RRCS may attach to the construction beam without interfering with such obstacles. The obstacles may, for example, include plumbing, panels, electrical wiring, and/or other structural items related to construction.

FIG. 4 depicts a free body diagram of an exemplary RRCS. The moment free body 500 of an RRCS depicts the moments acting upon a RRCS in a use case scenario. The weight of the RRCS and what it is supporting is represented by a weight W. The weight W is located an L distance away from the second stud. The weight generates a moment along the pivot of the second stud. The second stud is distanced a L2 distance from the first stud. Structurally, for the RRCS to be stable the net moment may, for example, be required to be 0 and the net moment translationally in the X and Y directions may, for example, be required to be 0. In this model, external force is not being applied in the translationally in the X direction. The force distribution between the first and second study may not be uniform. A lever ratio may be applied to model the forces applied to the studs.

$$Σ {M}_{2} = 0 = W * {L}_{1} - {L}_{2} * {R}_{x y} \qquad ( 1 )$$

$$N\_ 2 = W * \frac{{L}_{1}}{{L}_{2}} \qquad ( 2 )$$

The reactive force R_{xy} may be modeled by determining the force in the x-direction and the y-direction. For example, the frictional force in the Y direction stud for is i.e., Fₙ₁*μ₁. For example, the stud experiences a normal force Fₙ₁ created by its application of force against the normal beam due to the moment.

A free body diagram at the first stud 125 depicts a force F_{xy1} in the XY direction being applied to the construction beam. A net normal force Fₙ₁ perpendicular to the construction beam is generated in reaction to the F_{xy1}.

A free body diagram at the second stud 130 depicts a force F_{xy2} in the XY direction being applied to the construction beam. A net normal force Fₙ₂ perpendicular to the construction beam is generated in reaction to the F_{xy2}.

Frictional force is calculated by determining the y between the two materials and multiplying with the normal force. Frictional forces always oppose the direction of motion. The normal force is always perpendicular to the surface of the structure where force is being applied to.

$${F}_{f} = μ * {F}_{n} \qquad ( 3 )$$

In both free body diagrams of 125 and/or 130, the frictional force resists a force downward created from the weight and the moment of FRCS.

$$Σ Y = 0 = W + {F}_{{n}_{1}} * {μ}_{1} + {F}_{{n}_{2}} * {μ}_{2} \qquad ( 4 )$$

The sum of the Y Forces ΣY must equal 0 for the RCCS to remain structurally static. The frictional forces of the contact area between the stud and the construction beam work to support the weight applied to the RRCS.

FIG. 5 depicts a customized exemplary RRCS 500 with accessories. The RRCS 500 includes studs which that are coupled with an abrasive 515. The abrasive may, for example, be rubber, cloth, and or a gritty material. The frictional force coefficient μ is dependent on the surface material of the construction beam and the material of the RRCS being made in contact with the construction beam. A higher coefficient friction may, for example, decrease the chance of an accident caused by the slipping of the bar and the construction beam.

The RRCS 500 may include a built-in tray 505. The tray 505 may deploy fold out into three separate trays. The number of deployable trays may, for example, be just 2, 4, and or 5. The trays may, for example, include smaller trays or drawers. The tray 505 includes grooves 530. The grooves may, for example, prevent the sudden movement of tools 535 lying on the tray such as from rolling. The tray 505 includes a light module 520. The lights may, for example, be used at night and/or in dark places. The lights may, for example, be attached to a switch to turn on and off the lights. In some implementations, a smart device may communicate to the RCCS to turn on and off the light.

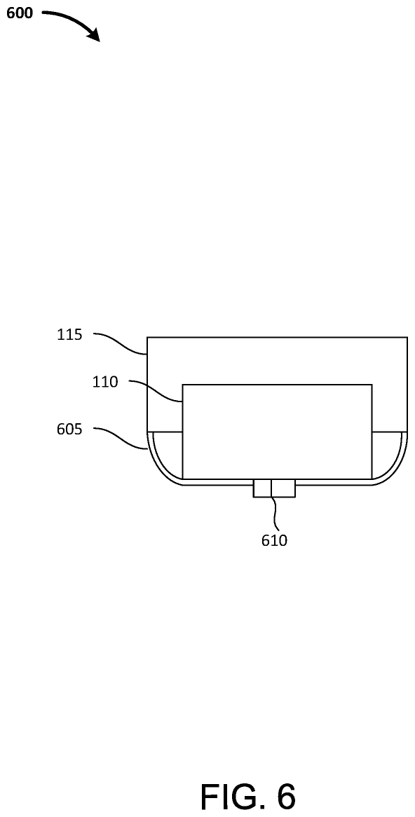

FIG. 6 depicts an exemplary RRCS 110 being coupled to a construction beam. The RRCS includes a tray accessory of 120. The tray accessory 120 is coupled to the RRCS by means of a strap 605. The strap includes a clip 610. The straps may for example, be adjustable by use of a strap adjuster. The straps may, for example, include a polyester, nylon, bungie cords, and/or other fastening materials. There may, for example, one or more straps being used to couple the RRCS to the tray. For instance, one, two, three, four, or more straps may be used to couple the RRCS to the tray.

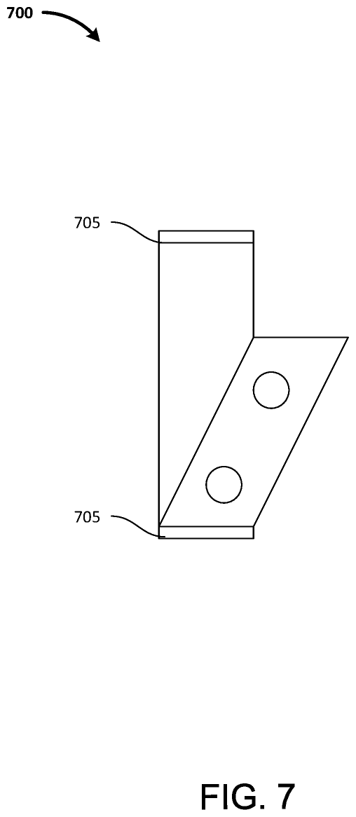

FIG. 7 depicts a foldable exemplary RRCS 700. The foldable exemplary RRCS 700 includes folding clips 705. The folding strips may allow the RRCS to fold. The folding strips may, for example, advantageously allow the RRCS to deploy and provide structural force, such as through a switch, to prevent bending. A foldable RRCS may, for example, be stored in a compact space. The RRCS includes a deployable mode. The RRCS includes a stowage mode. A foldable RRCS in a stowage mode may, for example, be stored in a compact space. The opposing arms of the RRCS may, for example, be rotatably coupled to the shelf. The opposing arms may, for example, fold to align their direction with the RRCS such that the RRCS enters the stowage mode. The opposing arms may, for example, be detachable and be stowed separately in some embodiments. A foldable RRCS in a deployed mode may, for example, be used to support a workbench.

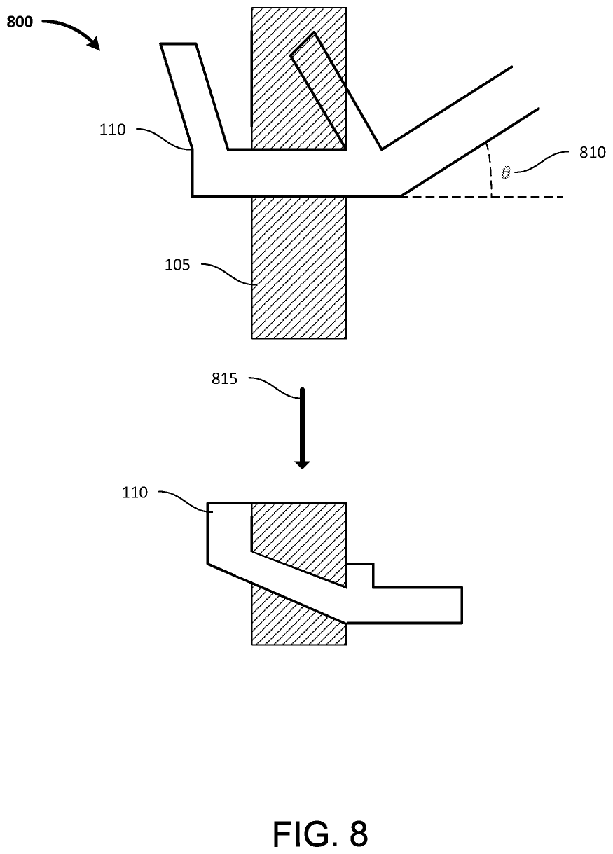

FIG. 8 depicts an attachment and in-use mode scenario 800 for an exemplary RRCS. The RRCS may be maneuvered in an attachment mode so the so the studs of the RCRS 110 run parallel to the edges of the construction beam 105. The shaft will be positioned a degree θ theta from the construction beam.

The RRCS then may be set into a deployment mode 815. The shaft is now perpendicular to the construction beam. The studs are applying a force against the construction beam. The frictional forces between the studs and the construction beam will allow the RRCS to remain structurally secure in the same place. The force acted upon the beam is levered by a mechanical advantage of the length of the shaft compared to the length of the head. The higher the mechanical advantage ratio the greater force is applied to the beam. Greater forces being applied to the beam may, for example, allow for a lower coefficient of friction being applied to the beam. The greater force being applied to the beam may, for example, prevent slipping from sudden impulses being applied to the RRCS.

Although various embodiments have been described with reference to the figures, other embodiments are possible.

Although an exemplary system has been described with reference to FIG. 1-8 and Appendixes A-C, other implementations may be deployed in other industrial, scientific, medical, commercial, and/or residential applications. For example, an RRCS may, for example, be used to hold other material besides tools necessary for construction. The RRCS may, for example, be used to attach a beam to hold tools used for painting, medical first aid, office supplies, and or shelving.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A repositionable construction shelf comprising:
a construction shelf extending along a longitudinal direction;
opposing arms extending along an intersecting axis to the longitudinal direction of the construction shelf, each opposing arm comprising:
opposing protrusions extending transversely from a same side of the opposing arms, configured such that the opposing protrusions may releasably couple the opposing arms to at least one adjacent vertical construction beam such that the opposing protrusions are positioned such that a distal protrusion is higher than a proximal protrusion such that a weight of the shelf urges both protrusions to frictionally engage with the vertical construction beam;
wherein the shelf comprises coupling features configured such that:
in a deployed mode configuration, the opposing arms are slidably coupled to the construction shelf by the coupling features and,
in a stowage configuration, the opposing arms are stowable by aligning the extending arms with the longitudinal direction of the construction shelf.

2. The repositionable construction shelf of claim 10, wherein the arm comprises a first portion configured to be coupled to the construction shelf and extending along the axis, and a second portion, extending along a second axis intersecting the axis, the arm configured such that, when the arm is releasably coupled to the vertical construction beam and supporting the construction shelf:
the first portion is angled upwards and away from the construction shelf, and
the second portion is horizontal.

3. The repositionable construction shelf of claim 1, wherein the shelf comprises a stowage cavity configured to be open upwards when the construction shelf is releasably coupled to the vertical construction beam.

4. The repositionable construction shelf of claim 1, wherein the construction shelf further comprises a cover releasably coupled to the construction shelf such that the cover is operable between an open position and a closed position.

5. The repositionable construction shelf of claim 4, wherein the cover is hingedly coupled to the construction shelf.

6. The repositionable construction shelf of claim 4, further comprising a latch mechanism configured to lock the operable cover.

7. The repositionable construction shelf of claim 6, wherein the cover further comprises a first segment and a second segment configured to fold in opposing directions such that, when the first segment and the second segment are folded flat, they form a substantially continuous working surface area.

8. The repositionable construction shelf of claim 1, wherein the construction shelf further comprises a light module, electrically coupled to a battery and a human interface switch, coupled to the construction shelf to illuminate a storage module of the construction shelf.

9. A repositionable construction shelf comprising:
a construction shelf extending along a longitudinal direction;
an arm extending along an axis intersecting the longitudinal direction of the construction shelf when the construction shelf is supported in a horizontal orientation across the arm;
opposing protrusions extending transversely from a same side of the arm, configured such that the opposing protrusions may releasably couple the arm to a vertical construction beam,
wherein the opposing protrusions are positioned on the arm such that a distal protrusion is higher than a proximal protrusion, when the arm is disposed on the vertical construction beam, such that a weight of the construction shelf urges both protrusions to frictionally engage with the vertical construction beam in opposing directions.

10. The repositionable construction shelf of claim 9, further comprising a second arm configured to be coupled to a second vertical construction beam adjacent the vertical construction beam, such that the construction shelf is supported by both the arm and the second arm.

11. The repositionable construction shelf of claim 9, wherein the shelf comprises coupling features configured such that:
in a deployed configuration, the opposing arms are slidably coupled to the construction shelf by the coupling features and,
in a stowage configuration, the arm is stowable by aligning the extending arms with the longitudinal direction of the construction shelf.

12. The repositionable construction shelf of claim 9, wherein the arm comprises a first portion configured to be coupled to the construction shelf and extending along the axis, and a second portion, extending along a second axis intersecting the axis, the arm configured such that, when the arm is releasably coupled to the vertical construction beam and supporting the construction shelf:
the first portion is angled upwards and away from the construction shelf, and
the second portion is horizontal.

13. The repositionable construction shelf of claim 9, wherein the shelf comprises a stowage cavity configured to be open upwards when the construction shelf is releasably coupled to the vertical construction beam.

14. The repositionable construction shelf of claim 13, wherein the stowage cavity is configured to store an electric tool.

15. The repositionable construction shelf of claim 13, wherein the stowage cavity is configured to store fasteners.

16. The repositionable construction shelf of claim 9, wherein the construction shelf further comprises a cover releasably coupled to the construction shelf such that the cover is operable between an open position and a closed position.

17. The repositionable construction shelf of claim 16, wherein the cover is hingedly coupled to the construction shelf.

18. The repositionable construction shelf of claim 16, further comprising a latch mechanism configured to lock the cover.

19. The repositionable construction shelf of claim 18, wherein the cover further comprises a first segment and a segment configured to fold in opposing directions such that, when the first segment and the second segment are folded flat, they form a substantially continuous working surface area.

20. The repositionable construction shelf of claim 9, wherein the construction shelf further comprises a light module, electrically coupled to a battery and a human interface switch, coupled to the construction shelf to illuminate a storage module of the construction shelf.
